(19) United States
(12) Patent Application Publication
(10) Pub. No.: US 2013/0232672 A1
(43) Pub. Date: Sep. 12, 2013

(54) INFRARED-PROTECTIVE GARMENT

(71) Applicants: Uwe Reischl, Boise, ID (US); Ravindra S. Goonetilleke, Eagle, ID (US)

(72) Inventors: Uwe Reischl, Boise, ID (US); Ravindra S. Goonetilleke, Eagle, ID (US)

(73) Assignee: Boise State University

(21) Appl. No.: 13/603,229

(22) Filed: Sep. 4, 2012

Related U.S. Application Data
(60) Provisional application No. 61/530,848, filed on Sep. 2, 2011.

(51) Int. Cl. A62B 17/00

(52) U.S. Cl. CPC A62B 17/00
USPC 2/455

(57) ABSTRACT

A protective garment includes a panel of substantially infrared-opaque material, having an inside and an outside, suitable for wearing by a person. The panel includes a plurality of spacers, disposed on the inside, configured to keep the panel away from direct contact with the person.

### RELATED APPLICATION DATA

The present application claims priority from U.S. Provisional Patent Application Ser. No. 61/530,848, filed on Sep. 2, 2011 and entitled INFRARED-PROTECTIVE GARMENT, the disclosure of which is incorporated herein by reference in its entirety.

### BACKGROUND

1. Field

The present application generally relates to radiation-protective garments. More particularly, the present application relates to a lightweight garment that attenuates infrared heat radiation exposure, without imposing significant heat insulation heat gain upon the user.

2. Related Art

Solar infrared radiation can impose a significant heat load on people who are engaged in outdoor occupational activities. Agricultural workers and construction workers, for example, are known to be at high risk of heat stress. This situation is of particular concern when persons are required to work in arid climates with high ambient air temperatures and intense daytime sunshine. Such conditions can lead to serious heat illnesses. Tents, hats, and other protective equipment can be used to help reduce solar heat exposure, but such measures are often impractical where people are engaged in complex manual tasks, interact with various tools and equipment, or are required to change body posture and/or location frequently. Moreover, wearing protective garments in some cases can be counter-productive because many garments that are currently known and used for sun protection can impose significant heat stress by adding insulation and reducing air flow over the skin. This, in turn, reduces convection and subsequent sweat evaporation.

Physiologically, the human body is a metabolic heat-generating system which must maintain a balance between heat loss and heat gain within a narrow temperature range. Environmental parameters such as air temperature, air velocity, heat radiation, and humidity can affect this delicate balance. Clothing material and garment design also affect the heat balance by promoting or reducing heat exchange through sweat evaporation, convection, conduction, and heat radiation. In general, the protective performance of fabrics is related to the chemical and physical structure of the fabric material, including thickness and weight. Woven textile materials generally do not offer a good barrier against infrared radiation. While their performance is generally better when the fabric thickness is greater and when the fabric material is heavier, thicker fabrics tend to be counterproductive for cooling purposes because they add thermal insulation and reduce air flow next to the skin.

The present application is directed to overcoming, or at least reducing the effects, of one or more of the issues set forth above.

### SUMMARY

It has been recognized that it would be advantageous to develop a garment that protects the wearer from infrared radiation, without imposing significant heat insulation heat gain upon the wearer.

It has also been recognized that it would be advantageous to develop an infrared-protective garment that is light-weight and inexpensive, and is flexible and comfortable so as not to interfere with a wide variety of body motions and tasks.

In accordance with one aspect thereof, the present application discloses an infrared-protective garment including a panel of substantially infrared-opaque material, having an inside and an outside, suitable for wearing by a person. The garment includes a plurality of spacers, disposed on the inside, configured to keep the panel away from direct contact with the person.

In one exemplary embodiment, the spacers are configured to keep the panel about 1 cm to about 4 cm away from direct contact with the person. In some embodiments, the outside of the panel is reflective. In some embodiments, the garment comprises a vest.

In accordance with another aspect thereof, the present application discloses a protective garment including a panel of flexible, substantially infrared-opaque material, having an inside and an outside, suitable for wearing by a person. The inside includes means for spacing the panel away from direct contact with the person while wearing the garment.

In accordance with yet another aspect thereof, the present application discloses a method for making an infrared-protective garment. The method includes forming a garment of flexible, substantially infrared-opaque material, having an inside and an outside, and providing a spacing mechanism on the inside. The spacing mechanism is configured to space the material away from direct contact with a wearer, thereby defining a cavity suitable for air circulation between the infrared-opaque material and the wearer.

These and other embodiments of the present application will be discussed more fully in the description. The features, functions, and advantages can be achieved independently in various embodiments of the claimed invention, or may be combined in yet other embodiments.

### BRIEF DESCRIPTION OF THE DRAWINGS

FIGS. 1A-B are front and rear views, respectively, of an embodiment of a infrared-protective garment in accordance with the present application.

FIG. 2 is a top view of the infrared-protective garment of FIGS. 1A-B.

FIGS. 3A-B are front and back views, respectively, of a person wearing an embodiment of an infrared-protective garment in accordance with the present application.

FIG. 4 shows disconnected front and back panels of the garment of FIGS. 2A-C, with the inner surfaces of the panels showing.

FIG. 5 shows disconnected front and back panels of the garment of FIGS. 2A-C, with the outer surfaces of the panels showing.

### DETAILED DESCRIPTION

Illustrative embodiments are described below as they might be employed in an infrared-protective garment. In the interest of clarity, not all features of an actual implementation are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

Further aspects and advantages of the various embodiments will become apparent from consideration of the following description and drawings. These embodiments are described in sufficient detail to enable those skilled in the art to practice the invention, and it is to be understood that modifications to the various disclosed embodiments may be made, and other embodiments may be utilized, without departing from the spirit and scope of the present invention. The following detailed description is, therefore, not to be taken in a limiting sense.

Solar heat radiation can impose significant heat stress on persons performing outdoor tasks. Advantageously, a lightweight, inexpensive garment has been developed that protects the wearer from infrared radiation, such as from the sun or other source, without imposing significant heat insulation heat gain upon the wearer. The development of this protective garment was undertaken to offer an alternative strategy for protecting people from high levels of solar radiation. It is believed that this garment is particularly useful for laborers who work outdoors, such as agricultural or construction workers, particularly in hot and arid climates, but it can also be used in other conditions where people are exposed to infrared radiation, such as laborers who work near furnaces or kilns and firefighters who are exposed to fires. Thus, references herein to solar radiation and infrared radiation, or to sun-protective and infrared-protective are used interchangeably, and any source of infrared radiation is intended.

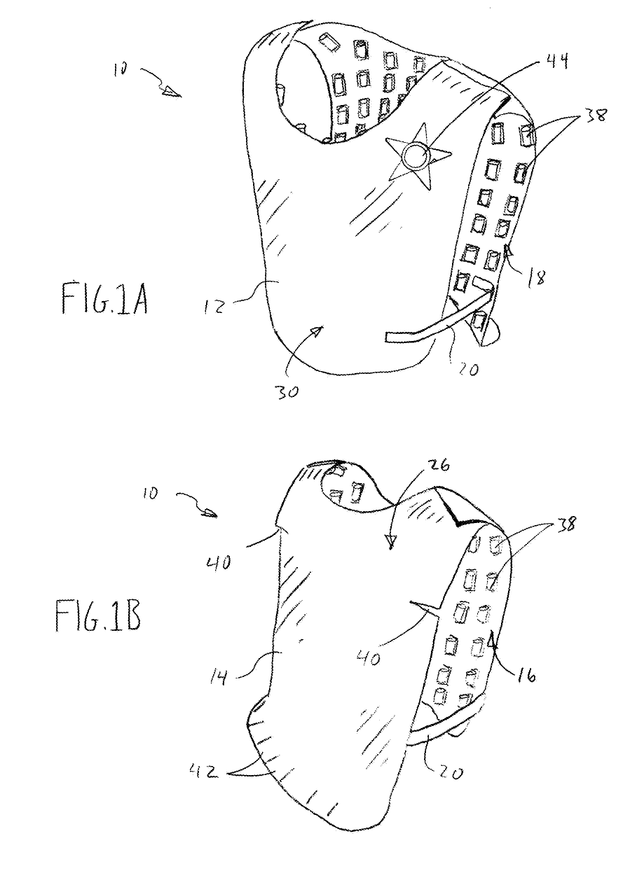

FIGS. 1-5 illustrate several exemplary embodiments of an infrared radiation-protective garment configured in accordance with the present application. Referring to FIGS. 1A and 1B, a garment 10 generally includes a front panel 12 and a back panel 14, made of flexible, substantially infrared-opaque material. As used herein, the term “infrared-opaque” is intended to mean blocking at least about half of incident infrared radiation.

While the garment 10 shown in the figures is configured as a vest, it is to be understood that this is only one embodiment of a protective garment that can be produced in accordance with this disclosure. The principles disclosed herein apply to a wide variety of types of garments, such as vests, jackets, shirts, coveralls, robes, hats, shoes and other types of garments. Indeed, an infrared-protective garment in accordance with this disclosure can be configured in almost any garment style, thus allowing it to meet the style and clothing preferences of any region, as well as the needs for particular uses. For example, different styles of garments that employ the features disclosed herein may be used in different regions of the world, such as the Middle East, Southeast Asia, or Central America.

Additionally, garments of different configurations can be used for different activities. For example, a garment that covers only the back of a person may be useful for agricultural workers who bend over to work, and generally only expose their backs to the sun. On the other hand, a garment that covers only the front of a person may be desirable for workers who periodically approach a furnace or kiln, for example.

A variety of materials can be used for the panels 12, 14. In one embodiment, the panels 12, 14 comprise a cardboard-type material that is about 1 mm thick. Cardboard is highly infrared-opaque, lightweight, inexpensive and relatively flexible. Other cardboard or paper-type materials can also be used. Plastics or polymer materials can also be used. Closed cell polystyrene foam material (also called “craft foam”) is also believed to be suitable, providing an infrared-opaque material that is lightweight and flexible. It should also be recognized that a multi-layer material can be used for the panels 12, 14. For example, it is believed that a closed cell material can be bonded to a cardboard material, or a metal layer (e.g. metal foil) can be bonded to a cardboard or foam material. A variety of multi-layer configurations can be used and tested to take advantage of different characteristics of various materials.

Generally, woven fabrics are not highly infrared-opaque, meaning that they transmit a substantial quantity of incident infrared radiation. However, woven fabrics could be suitable for use in a sun protective garment in accordance with this application, depending upon their thickness and weave, and where a suitable air gap is provided. It is also believed that non-woven fabrics can be suitable, depending upon the type of fabric and its particular infrared resistant characteristics. For example, certain felt materials can be suitable for an infrared-protective garment as disclosed herein.

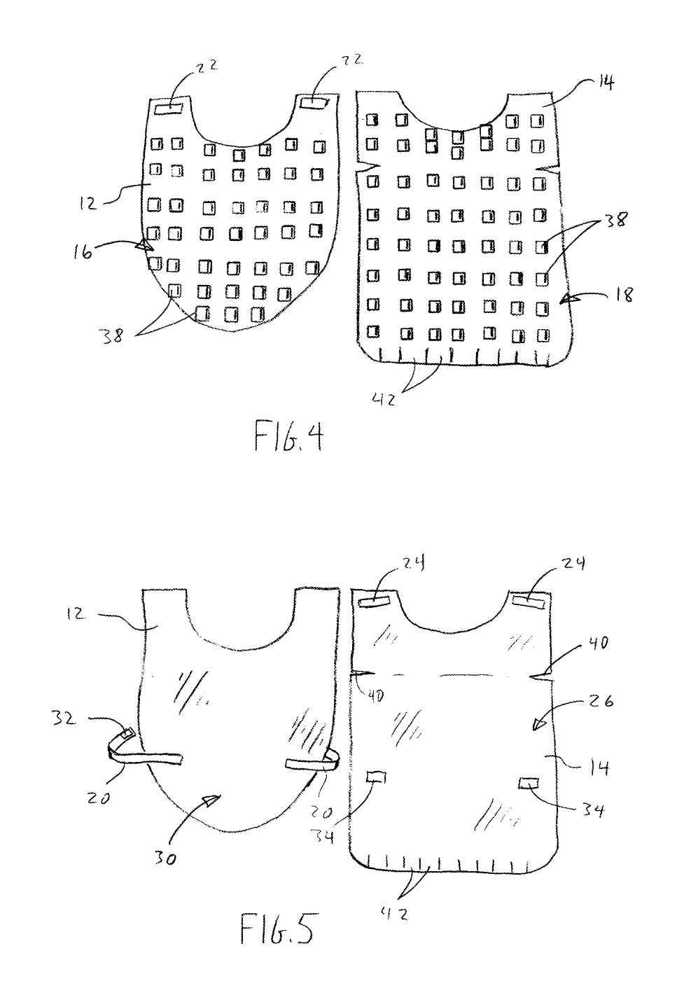

In the embodiment shown in FIGS. 1A and B, the front panel 12 and back panel 14 attach together at the shoulders and along the sides to form a vest. The front panel 12 has an inside surface 16 and an outside surface 30, and the back panel 14 has an inside surface 18 and an outside surface 26. When the vest parts are connected together, the inside surfaces 16, 18 face each other to define the inside of the garment 10. In the embodiment shown in FIGS. 1A and B, the front and back panels 12, 14 are detachably connectable at the shoulders, using a releasable fastener (e.g. hook and loop fabric such as Velcro®), and the sides of the panels 12, 14 connect together via releasable straps 20. The configuration of these fasteners and straps are shown more clearly in the disassembled views of FIGS. 4 and 5.

Viewing FIG. 4, the fasteners 22, which can include pieces of hook and loop material, can be attached near the shoulder region on the inside surface 16 of the front panel 12. Viewing FIG. 5, corresponding fasteners 24, such as corresponding pieces of hook and loop material, can be attached to the outside surface 26 of the back panel 14. The fasteners 22, 24 at the shoulders of the garment 10 allow the front and back panels 12, 14 to be releasably attached together, allowing the garment 10 to be adjusted to fit a given individual, while also allowing the separate pieces of the garment 10 to be stored in a substantially flat configuration. While the shoulders of the garment 10 can be releasably attachable by hook and loop material (e.g. Velcro®), it is to be appreciated that other types of releasable fasteners 22, 24 can also be used, such as snaps, zippers, buttons, etc. It will also be appreciated that a garment 10 configured as a vest in accordance with the present application can be created that is continuous over the shoulders, rather than being detachable and having separate front and back panels 12, 14.

In the illustrated embodiments, the lower or mid region of the front panel 12 includes side straps 20, which are attached to the outside surface 30 of the front panel 12. The side straps 20 have a releasable fastener 32 disposed at their distal ends, such as hook and loop material. These fasteners 32 are configured to attach to corresponding fasteners 34, such as opposing pieces of hook and loop material, disposed on the outer surface 26 of the back panel 14. As shown in FIGS. 3A and 3B, when the garment 10 is placed over the shoulders of a wearer 36, the sides can be releasably attached together with these side straps 20. Again, it is to be appreciated that other types of releasable fasteners or attachment mechanisms for the side straps 20 can be used, in addition to the hook and loop fabric that is described.

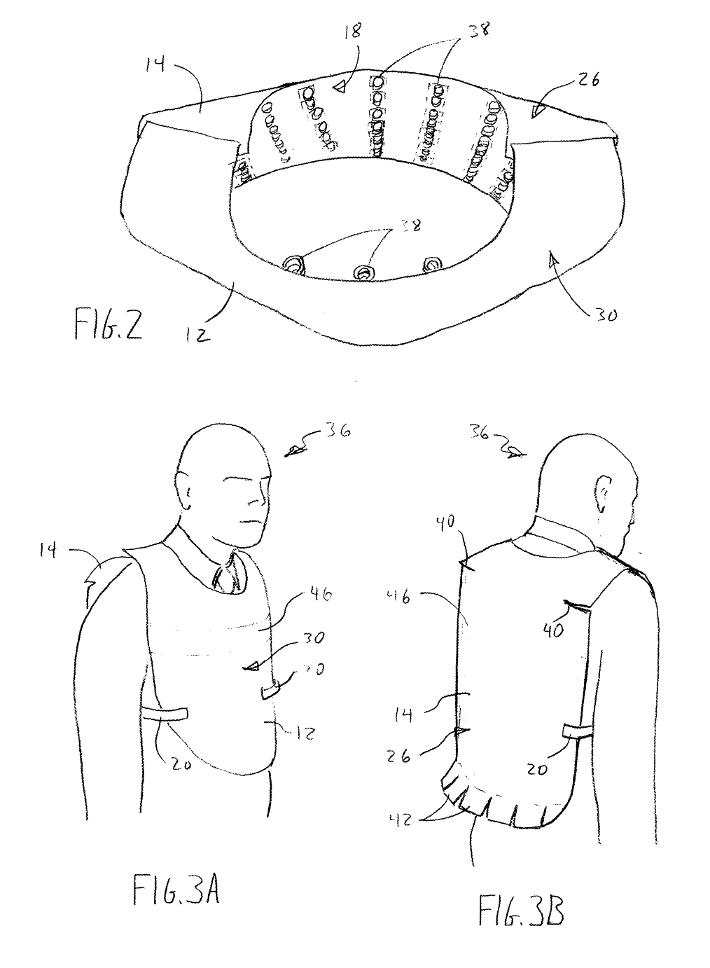

In the illustrated embodiments, the garment 10 comprises a number of spacers 38 located on the inside surfaces 16, 18 of the front and back panels 12, 14. In the embodiments shown in the figures, the spacers 38 comprise small, plastic ring-type spacing devices attached to the inside surfaces 16, 18 of the front and back panels 12, 14. The ring-type configuration of the spacers 38 is most clearly visible in the top view of FIG. 2. In use, the spacers 38 serve to hold the inside of the garment 10 away from direct contact with a wearer 36, thus defining a cavity suitable for air circulation between the garment 10 and the wearer 36. The spacers 38 can also limit the area of contact with the wearer 36, while also minimizing any potential blockage of air circulation in the air cavity.

The size of the spacers 38 can vary. For example, in some embodiments, the spacers 38 have a height within the range of about 1 cm to about 4 cm, thereby creating a space of about 1 cm to about 4 cm between the wearer 36 and the panels 12, 14. In some specific embodiments, the spacers 38 have a height of about 1.6 cm, or a height of about 3.2 cm. In general, the size of the spacers 38 can be selected to suit differing environmental conditions and desired levels of cooling. The number and spacing of the spacers 38 can also vary, depending on the size and shape of the spacers, and the rigidity of the panels 12, 14. For example, a more rigid panel material may require fewer spacers 38, while a more flexible panel material may require more spacers 28 to keep the panels 12, 14 out of direct contact with the wearer 36.

The configuration of the spacers 38 can also vary. For example, polymer foam balls, foam rubber blocks or balls, and other spacer devices can be used, in addition to the ring-type spacers shown. It is also believed that newly-developed or yet-to-be-developed materials that change size or shape depending on temperature could be used. For example, spacers that expand with increasing temperature, thus increasing the air circulating cavity size when temperature increases, can be used. In general, any type of spacing mechanism can be used that holds the panels 12, 14 substantially out of direct contact with the wearer 36 and provides a cavity between the panels 12, 14 and the wearer 36 in which air can circulate. It is also desirable that the spacing mechanism be lightweight.

As shown in FIGS. 1-5, the garment 10 can include various flexibility-enabling features that aid and enable its wearability, such as darts, slits, etc. For example, as shown in FIGS. 1B, 3B and 5, the back panel 14 of the garment 10 can include shoulder slits 40 that help enhance the flexibility of the garment 10 over the shoulders. The bottom of the back panel 14 can also include a plurality of slit lumbar flaps 42, which increase the flexibility of the garment 10 in the lower back region. Other flexibility-enhancing features can also be included, depending on the flexibility of the panel material and the type and shape of the garment.

The outside of the garment 10 can have a variety of surface features. For example, the outside surfaces 26, 30 of the panels 12, 14 can be treated to be reflective. In one specific embodiment, a plastic reflective (e.g. aluminized) surface is provided on the outside surfaces 26, 30 of the panels 12, 14. Aluminum is known to reflect about 50% of incident infrared radiation. However, aluminum also releases heat very easily, causing an aluminum shell to radiate substantial heat inwardly, thus potentially negating some of the gain due to reflection. Other reflective surface materials or treatments can also be used to increase the reflection of incident radiation. Similarly, the color and sheen of the panel material can be selected to reflect infrared radiation as much as possible. On the other hand, non-reflective materials can also be used.

Indicia or other surface treatments can also be applied to the outer surface of the garment 10. For example, as shown in FIG. 1A, the outside of the garment 10 (e.g., the outside surface 30 of the front panel 12) can have a logo 44 or other indicia applied to it, such as for advertising or identification purposes. Similarly, a reflective stripe 46, shown in FIGS. 3A-B, can be applied to make the garment 10 more visible for safety purposes. This can be desirable for highway construction workers and the like. Indeed, the entire exterior of the garment 10 can be made reflective or highly visible for safety or identification purposes. It will be apparent that other indicia or surface treatments can also be applied to the outside of a garment 10 configured in accordance with this disclosure.

Several vests configured in accordance with this disclosure have been made and tested in laboratory conditions using a thermal mannequin exposed to controlled heat radiation intensity levels. The results of these tests were published in Uwe Reischl, et al., “Thermal Characteristics of Infrared Radiation Protective Vests,” SIGURNOST, Vol. 53, No. 1, April, 2011 (Institute of Safety Research and Development, Zagreb, Croatia). This article is incorporated by reference herein in its entirety, and attached hereto as Appendix A. In general, the tests showed that a vest constructed in accordance with the present disclosure was able to provide substantial protection against infrared heat loading while imposing only very minor insulation heat gain. In particular, a vest having a 1 mm thick, non-reflective cardboard panel and including 3.2 cm flexible ring spacers was able to reduce heat gain by 30% without imposing a significant corresponding insulation heat gain.

The protective garment disclosed herein can significantly reduce infrared heat stress exposure by providing shielding against heat radiation while not imposing a measurable metabolic heat build-up for the wearer. Placing flexible spacers inside the garment enhances metabolic heat dissipation through air circulation (convection). The space between the garment and the wearer also allows the garment material to cool as it is heated by the infrared radiation, and prevents the garment from transferring heat to the skin by conduction. Use of this sort of garment by agricultural workers and construction workers exposed to high intensity sunlight environments could be very beneficial. The application of this technology in hot regions may provide economic advantages by promoting occupational health and safety and improving productivity in the field.

Although this invention has been described in terms of certain preferred embodiments, other embodiments that are apparent to those of ordinary skill in the art, including embodiments that do not provide all of the features and advantages set forth herein, are also within the scope of this invention. Accordingly, the scope of the present invention is defined only by reference to the appended claims and equivalents thereof.

What is claimed is:

1. A protective garment, comprising:
a panel of substantially infrared-opaque material, having an inside and an outside, suitable for wearing by a person; and
a plurality of spacers, disposed on the inside, configured to keep the material away from direct contact with the person.

2. A garment in accordance with claim 1, wherein the material is a cardboard-type material.

3. A garment in accordance with claim 1, wherein the material of the panel blocks at least about 50% of incident infrared radiation.

4. A garment in accordance with claim 1, wherein the outside of the panel comprises a reflective surface.

5. A garment in accordance with claim 1, wherein the spacers are configured to keep the panel about 1 cm to about 4 cm away from direct contact with the person.

6. A garment in accordance with claim 1, wherein the garment comprises a vest.

7. A garment in accordance with claim 1, wherein each of the spacers comprise a resilient ring, having a diameter oriented substantially perpendicular to the panel at a respective location of attachment.

8. A protective garment in accordance with claim 1, further comprising indicia, disposed on the outside of the panel.

9. A protective garment, comprising:
a panel of flexible, substantially infrared-opaque material, having an inside and an outside, suitable for wearing by a person; and
means, disposed on the inside, for spacing the panel away from direct contact with the person while wearing the garment.

10. A protective garment in accordance with claim 11, wherein the means for spacing comprises a plurality of spacers, disposed on the inside of the panel, configured to retain the material away from direct contact with the person.

11. A protective garment in accordance with claim 11, wherein the means for spacing is configured to retain the panel about 1 cm to about 4 cm away from direct contact with the person.

12. A protective garment in accordance with claim 11, wherein the panel of flexible, infrared-resistant material comprises a cardboard-type material.

13. A protective garment in accordance with claim 11, wherein the outside of the panel comprises a reflective surface.

14. A protective garment in accordance with claim 11, wherein the garment comprises a vest, having indicia disposed on the outside.

15. A method for making an infrared-protective garment, comprising:
forming a garment of flexible, substantially infrared-opaque material, having an inside and an outside; and
providing a spacing mechanism on the inside of the garment, configured to space the material away from direct contact with a wearer, thereby defining a

16. A method in accordance with claim 15, wherein providing a spacing mechanism comprises attaching a plurality of spacers to the inside of the garment.

17. A method in accordance with claim 15, wherein the spacing mechanism is configured to space the infrared-opaque material about 1 cm to about 4 cm away from the wearer.

18. A method in accordance with claim 15, further comprising providing a reflective surface on the outside of the infrared-opaque material.

19. A method in accordance with claim 18, wherein providing a reflective surface on the outside of the infrared-opaque material comprises providing an aluminized surface.

20. A method in accordance with claim 15, further comprising providing flexure-enabling features in the infrared-opaque material.
